(19) United States
(12) Patent Application Publication
(10) Pub. No.: US 2022/0351147 A1
(43) Pub. Date: Nov. 3, 2022

(54) WEEKLY EVENT REMINDER

(71) Applicant: John MANNINEN, Paradise, CA (US)

(72) Inventor: John MANNINEN, Paradise, CA (US)

(21) Appl. No.: 17/733,897

(22) Filed: Apr. 29, 2022

Related U.S. Application Data
(60) Provisional application No. 63/181,878, filed on Apr. 29, 2021.

(51) Int. Cl. G06Q 10/10

(52) U.S. Cl. CPC G06Q 10/1093

(57) ABSTRACT

A reminder device may include a first section, a second section, an indicator, and a proximity sensor. The first section may include a weekly display that may be divided into individual days. The second section may be adjacent to the first section and may include a display portion that may be divided into a plurality of display sections. Each section of the plurality of display sections may be associated with a day of the individual days. The indicator may be associated with the first section or the second section. The indicator may be configured to provide at least a first indication of a current day of the individual days. The proximity sensor may be coupled to the reminder device and may be configured to illuminate a portion of at least one of the first section, the second section, or the indicator.

### CROSS-REFERENCE TO RELATED APPLICATIONS

This application claims the benefit of U.S. Provisional Application Ser. No. 63/181,878, filed on Apr. 29, 2021, and titled “WEEKLY EVENT REMINDER”, the disclosure of which is incorporated herein by reference in its entirety.

### FIELD

The embodiments discussed in the present disclosure are related to a weekly event reminder.

### BACKGROUND

Unless otherwise indicated in the present disclosure, the materials described in the present disclosure are not prior art to the claims in the present application and are not admitted to be prior art by inclusion in this section.

Reminder devices often include a visual reminder of the day of the week and may also include a visual of events occurring during the days of the week. Some reminder devices may offer reduced viewing visibility and/or may be cost prohibitive. Some reminder devices consume large amounts of energy in continually displaying the days of the week and/or the associated events.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, a reminder device may include a first section, a second section, an indicator, and a proximity sensor. The first section may include a weekly display that may be divided into individual days. The second section may be adjacent to the first section and may include a display portion that may be divided into a plurality of display sections. Each section of the plurality of display sections may be associated with a day of the individual days. The indicator may be associated with the first section or the second section. The indicator may be configured to provide at least a first indication of a current day of the individual days. The proximity sensor may be coupled to the reminder device and may be configured to illuminate a portion of at least one of the first section, the second section, or the indicator.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example weekly reminder device;

FIG. 2 illustrates another example weekly reminder device; and

FIG. 3 illustrates another example weekly reminder device.

### DESCRIPTION OF EMBODIMENTS

Weekly reminder devices often fail to provide a simple space to enter and/or display data to be associated with days of the week. Some weekly reminder devices offer displays that consume a lot of energy in the display thereof, which may result in failures to display and/or frequent battery changes. Further, some weekly reminder devices fail to easily display information related to days of the week in such a way that can easily be viewed from afar, or viewed by multiple people.

The reminder device described herein may include weekly reminder device that displays the days of the week and may further include an indication of the time of day of the current day. Alternatively, or additionally, the reminder device may include a section adjacent to the day display that may include a display portion for data and/or information entry that may be associated with each individual day of the week. Further, the reminder device may include a proximity sensor configured to detect motion and illuminate the reminder device such that it may easily be viewed and conserve energy when not in use.

Embodiments of the present disclosure will be explained with reference to the accompanying drawings.

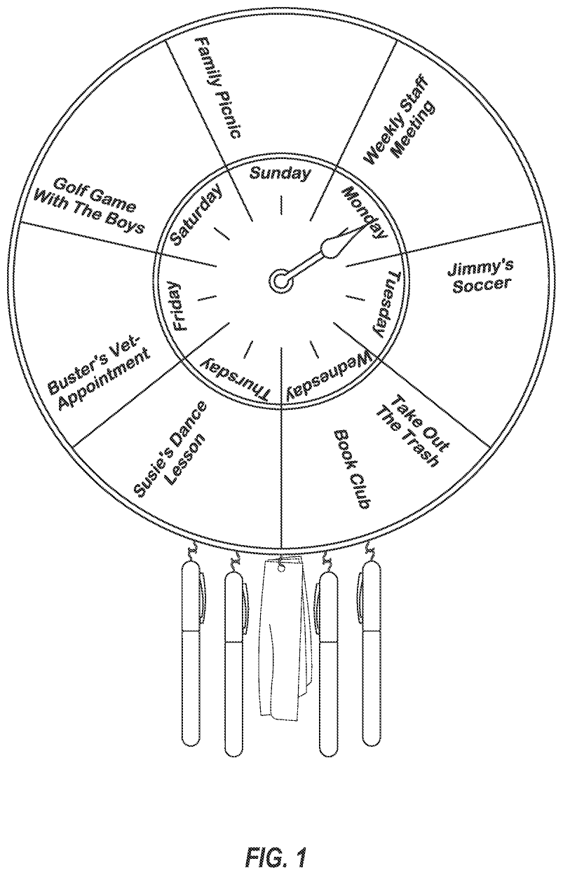

FIGS. 1, 2, and 3 illustrate different embodiments of a weekly reminder device, in accordance with at least one embodiment of the present disclosure.

Disclosed is a weekly reminder device, which may include some or all of the following components: a device to indicate the current day of the week; and a writable or enter electronic text surface. The forgoing components may be connected as follows: the day of the week indicator highlights one writable or enter electronic text surface area designated for one day of the week.

The weekly reminder device may also include one or more following components: a whiteboard writing surface area; a chalkboard writing surface area; a paper tablet writing surface area; an electronic text surface area; an analog day of the week indicator; a digital day of the week indicator; a light day of the week indicator; and a proximity motion detector.

The weekly reminder device may be unique when compared with other known devices and solutions because embodiments thereof may provide a device to point at the current day of the week and/or an area directly adjacent to and aligned with the day of the week indicator to manually enter written material.

The weekly reminder device may be unique in that embodiments thereof may be structurally different from other known devices or solutions. For example, the weekly reminder device may include a writable surface area that may be used in connection with a day of the week indicator, the writable surface may be very large and can be viewed from a distance, and/or the weekly reminder device may include very low power consumption.

In some embodiments, the weekly reminder device may include an analog day of the week indicator mounted in the center, that by its very nature not only points at the day of the week but also generally indicates what time of the day it is. The analog hand may point at one day of the week starting with midnight rotating through morning, afternoon, evening and night. Alternatively, or additionally, the analog day of the week indicator may align with a whiteboard area that may be positioned radially outward from the day of the week indicator and may be used for noting events and arranging them in an earliest to latest alignment such as morning, afternoon and evening. Alternatively, or additionally, colored writing instruments may be used to indicate priority events or for a designated person or group. In some embodiments, the writing instruments may be attached directly to the weekly event reminder which may make the weekly event reminder convenient, quick, and/or easy to use.

FIG. 1 illustrates an analog version using a battery powered clock face with one arm indicator at the center of the display. The clock face may be protected by a clear plastic cover. On the perimeter of the clock face, a writing surface may be included, such as a whiteboard, for the user to enter information. Another function the analog hand may perform is to first point to the morning of each day. The analog hand may then progress through the afternoon, and then evening. This analog hand progression may allow the user to chronologically order the events for that day. The battery powered analog day clock may be similar to commonly used battery powered analog time of day clocks, thus making it lightweight, inexpensive, and/or easy to manufacture. The dimensions of the weekly reminder device, including depth, may allow it to be placed in numerous locations without physical interference. Attachment to a vertical surface such as a wall can be accomplished with temporary fasteners, which may enable easy removal of the weekly reminder device from the wall allowing the user a more advantageous location to input information. Because the analog version does not depend on electronics, the weekly reminder device may not be subject to common malfunctions such as data loss, passwords, viruses or hacking. The analog version of the weekly reminder device may be persistently visible without any activation even for quick observation. The power use may be very low and may use one battery that may include a long operating life. Writing instruments can be mounted directly to the weekly reminder device for ease-of-use. The writing instruments can be of many different colors to add accent to the information or can be used for specific reasons such as to identify specific people or groups.

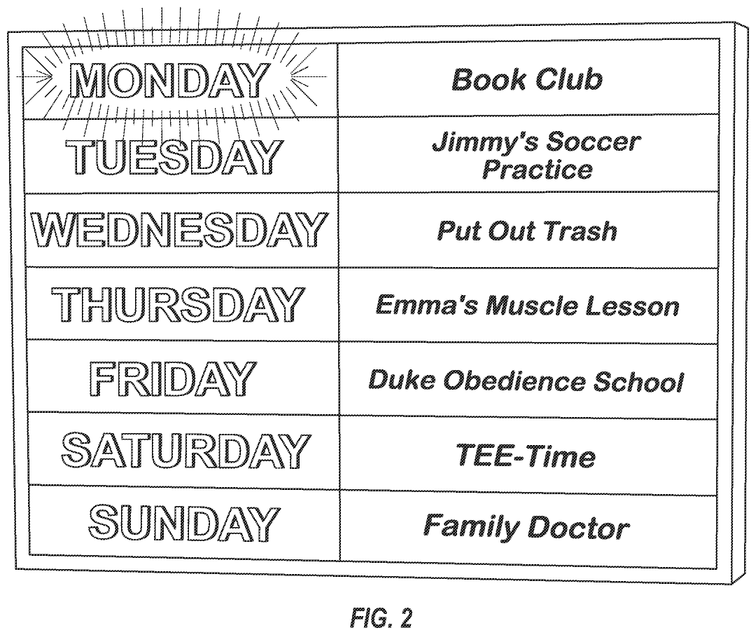

FIG. 2 illustrates a horizontally oriented weekly reminder device with the day of the week, on the left side, illuminated and/or backlit. The right side may include a writing surface such as a whiteboard, chalkboard, paper tablet, or an electronic text area, for the user to enter information. Electronic texts can be entered via a computer, keyboard, wireless device, and/or a plug-in memory device, to name a few examples. The display portion can be so designed to have the text flashing to indicate an event that is imminent or occurring right now. Other data can be input such as weather conditions which similarly can flash if it might affect listed activities. All indicators might be enhanced using a motion detector, such as a proximity sensor, to detect when a viewer is close by.

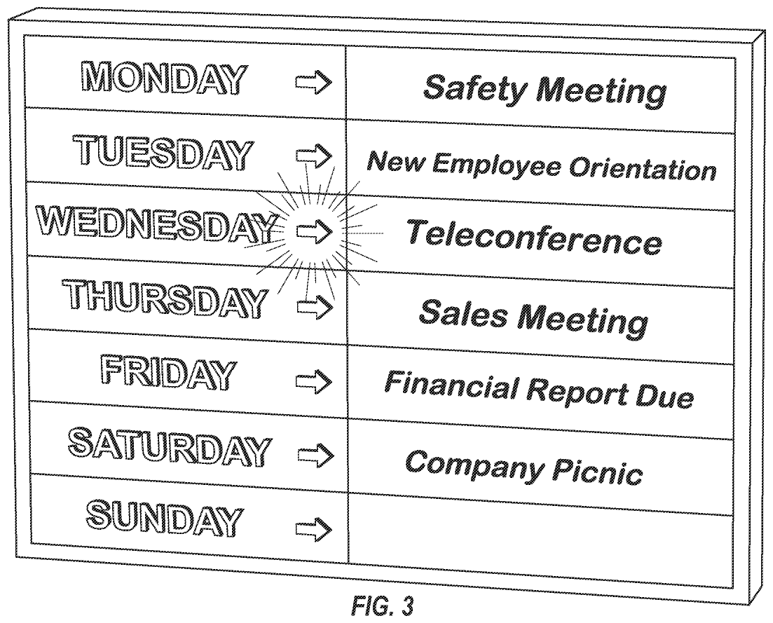

FIG. 3 illustrates another horizontally oriented weekly reminder device with all the similar features and including an illuminated arrow to point directly at the events taking place on that day.

In general, a weekly reminder device may include a surface to write on or enter electronic text segmented into days of the week with a current day of the week indicator, which may allow anyone in close proximity to visually be reminded of what day of the week it is and/or what is taking place on a daily basis. The weekly reminder device may include a surface to write on that may be divided into days of the week with an electrical or mechanical indicator to show the current day of the week.

In some embodiments, a mechanical or electrical device may be configured so as to point or illuminate the current day of the week with a writable or enter electronic text surface associated with that day of the week and similar areas for the other days of the week. The weekly reminder device can be used as an instant visual reminder not only to indicate what day of the week it is, but to also remind everyone what is taking place that day. Furthermore, the writing surface can be easily changed or updated, may not require electronics that could malfunction, and may be persistently visible to everyone passing by.

Modifications, additions, or omissions may be made to the weekly reminder device without departing from the scope of the present disclosure. For example, in some embodiments, the weekly reminder device may include any number of other components that may not be explicitly illustrated or described.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A reminder device, comprising:
a first section including a weekly display divided into individual days;
a second section adjacent to the first section and including a display portion divided into a plurality of display sections, each display section of the plurality of display sections associated with a day of the individual days;
an indicator associated with the first section or the second section and configured to provide at least a first indication of a current day of the individual days; and
a proximity sensor coupled to the reminder device and configured to illuminate a portion of at least one of the first section, the second section, or the indicator.

2. The reminder device of claim 1, wherein the first display portion is an analog display.

3. The reminder device of claim 1, wherein the indicator further comprises providing a second indication including a time of day of the current day.

4. The reminder device of claim 1, further comprising a hanging element configured to couple the reminder device to a surface.

5. The reminder device of claim 1, further comprising one or more attachment elements configured to support one or more writing instruments configured to interface with at least the second section.

6. The reminder device of claim 1, wherein the second section comprises an electronic display.

7. The reminder device of claim 1, wherein the second section comprises a whiteboard.

8. The reminder device of claim 1, wherein the second section comprises a chalkboard.

9. The reminder device of claim 1, wherein the second section comprises a paper tablet.

10. The reminder device of claim 1, wherein the indicator provides a second indication in instances in which a first condition is adverse to first data input into the second section.
